(19) United States
(12) Patent Application Publication
(10) Pub. No.: US 2019/0177199 A1
(43) Pub. Date: Jun. 13, 2019

(54) SEWAGE DEWATERING PROCESSES AND APPARATUSES

(71) Applicant: Franklin David Deskins, Fishers, IN (US)

(72) Inventor: Franklin David Deskins, Fishers, IN (US)

(21) Appl. No.: 16/217,042

(22) Filed: Dec. 11, 2018

Related U.S. Application Data
(60) Provisional application No. 62/597,731, filed on Dec. 12, 2017.

(51) Int. Cl. C02F 11/16; C02F 1/52

(52) U.S. Cl. CPC C02F 11/16; C02F 2103/005; C02F 1/5227

(57) ABSTRACT

A process of dewatering any liquid/solid materials, primary-treated or non-treated sewage which includes mixing the sludge with a coagulant or flocculant aid, usually activated polymer. The sludge is then mixed and flocculated at conditions which involve extensive mixing turbulence of the sludge and whereby part of the sludge is recycled so as to be again subjected to such mixing and flocculating. Flocks form the solid particles in the sludge. The pH of the sludge is chemically adjusted into the basic pH range or to a higher basic pH. The flocked material is applied to any mechanical or non-mechanical device or a sand bed whereby the flocculated solids in the sludge are separated from the liquid in the sludge, by collecting on the top of the sand bed. The flocculated solids located on the top of the sand bed are air dried. The dried flocculated solids are removed from the top of the sand bed.

### CROSS REFERENCE TO RELATED APPLICATION

This application claims the benefit under Title 35, U.S.C. § 119(e) of U.S. Provisional Patent Application Ser. No. 62/597,731, entitled SEWAGE DEWATERING PROCESSES AND APPARATUSES and filed on Dec. 12, 2017, the entire disclosure of which is hereby expressly incorporated by reference herein

### FIELD

This disclosure includes sewage dewatering processes and equipment that may carry out the processes.

### BACKGROUND

Sewage is composed of the liquid and water-carried wastes from residences, commercial buildings, industrial plants, and institutions, together with any groundwater, surface water and storm water which may be present. The terms “wastewater” and “sewage” are sometimes used interchangeably herein.

The composition of sewage depends on its origin and the volume of water in which the wastes are carried. Sewage which originates entirely from residential communities is made up of excreta, bathing and washing water, and kitchen wastes. Other wastes can be present from rural/agricultural sources and/or industrial or commercial establishments.

Modern sewage treatment is generally divided into three phases: primary, secondary and tertiary. Each of these steps produces sludge, which can be disposed of or used for various purposes.

Primary treatment, or plain sedimentation, removes only the settleable solids from sewage. A modern system for primary treatment entails collecting the sewage, conveying it to a central point for treatment, using both screens to remove large objects and grit chambers to remove grit, and using primary sedimentation tanks to remove the suspended settleable solids. This type of system produces about one third of a gallon of wet sludge per person per day, and facilities for handling and disposing of the sludge are also needed. Primary treatment reduces the concentration of suspended solids by about 60 percent and reduces the BOD (biochemical oxygen demand) by about 35 percent.

Secondary treatment involves the addition of a biological treatment phase following plain sedimentation. At best, this treatment removes about 85 to 95 percent of the organic matter in sewage. It has little effect on dissolved materials or on the nutrients that stimulate the growth of algae in the receiving waters. It also discharges all of the nutrients and dissolved solids, as well as any contaminants which may be added to the water by industrial plants.

There are two basic methods of often used in modern secondary treatment, that is, the trickling filter and the activated-sludge processes. In small communities, secondary treatment is sometimes accomplished by either the trickling-filter method or the contact bed method, but usually used is the sand filter method. In larger communities, secondary treatment is generally accomplished by the activated-sludge process.

Sand filters are beds of fine sand, usually 3 feet (1 meter) deep, through which the sewage slowly seeps. As it seeps through the sand, the organic matter is decomposed and stabilized by the microorganisms in the sewage. Sand filters require about 4 acres (1.6 hectares) of sand beds for each thousand people. Because of this large space requirement, sand beds have obvious disadvantages. Also, the time required for the sludge to be formed and dried usually takes weeks. This long drying time means that large surface areas of sand beds have to be used to achieve drying with the attendant large cost of constructing, operating and maintaining the sand beds. Rain adds time to the drying function of sand beds, since the sand beds usually are without any roof or other top covering. Covered sand beds require less area than do uncovered beds but still take weeks to achieve drying and have a higher construction cost. Nowadays, about 90 percent of smaller municipalities use sand beds to dewater sewage coming from primary treatment units. The main purpose of sand beds is the reduction of the water content in the primary-treated sewage.

A contact bed, composed of many layers of stone, slate or other inert material, provides a relatively large surface area for the growth of microorganisms. It operates on a fill-and-draw basis, and the organic matter delivered during the fill period is decomposed by the microorganisms on the bed. The oxygen required by the microorganisms is provided during the resting period, when the bed is exposed to the air.

In the trickling filter system, the sewage is applied to the filter through rotary distributors and, then, is allowed to trickle down over large stone or plastic beds that are covered with microorganisms. The beds are not submerged and, thus, air can reach the organisms at all times. The area requirements for trickling filters are about 5 to 50 acres (2 to 20 hectares) per million people.

In the activated-sludge process, heavy concentrations of aerobic microorganisms, called biological floc or activated sludge, are suspended in the liquid either by agitation which is provided by air which is bubbled into the tank or by mechanical aerators. Final sedimentation tanks are needed to separate the floc material from the flowing liquid. Most of the biologically active sludge, then, is then returned to the aeration tank with which to treat the incoming water. The high concentration of active microorganisms which can be maintained in the aeration tank permits the size of the treatment plant to be relatively small, about 1 to 5 acres (0.1 to 2 hectares) per million population.

Tertiary treatment is designed for use in areas either where the degree of treatment must be more than 85 to 95 percent or where the sewage, after treatment, is reused. It is mainly intended to further clean or polish secondary treatment plant effluents by removing additional suspended material and by lowering the BOD, generally by filtration. This polishing, however, has little impact on the dissolved solids, including the nutrients, synthetic organic chemicals, and heavy metals. To eliminate these constituents of sewage, other methods of treatment have been devised. These processes include coagulation and sedimentation, precipitation, adsorption on activated carbon or other adsorbents, foam separation, electrodialysis, reverse osmosis, ion exchange and distillation.

Sludge is the semiliquid mass removed from the liquid flow of sewage. Sludge will vary in amount and characteristics with the characteristics of sewage and plant operation. Sludge from primary treatment is composed of solids usually having a 95 percent moisture content. The accumulated solid materials, or sludge, from sewage treatment processes amount to 50 to 70 pounds (22 to 31 kg) per person per year in the dry state or about one ton (0.9 metric ton) per year in the wet state. Sludge is highly capable of becoming putrid, and can, itself, be a major pollutant if it is not biologically stabilized and disposed of in a suitable manner. Biological stabilization may be accomplished by either aerobic or anaerobic digestion. After digestion, sludge-drying beds are usually used.

In modern sewage treatment plants, mechanical dewatering of sludge by vacuum filters, centrifuges, or other devices is becoming widespread. The dewatered sludge, then, may be heat-dried, if it is to be reclaimed, or it may be incinerated. In large communities where large amounts of sludge are produced, mechanical dewatering and incineration are commonly practiced. But there are many smaller communities, rural areas, etc., which have economic constraints and which use the sand bed method to dewater sewage. There is a great need to make the sand bed method more economical by reducing the time for drying waste material (sludge) from the primary-treated sewage effluent and by reducing the time for drying the sludge. Reduced drying time would allow reduction of the size of the sand beds needed.

Early sludge treatment schemes included plain sedimentation, followed by chemical precipitation or sedimentation aided by flocculation chemicals. Chemical precipitation fell into disuse, but may be making a comeback. Nowadays, chemicals are often added to the sewage to promote the coagulation of the finer suspended solids, so that these solids become heavy enough to settle in sedimentation in the primary treatment stage. Typical chemical coagulants in the flocculation of sewage are alum, polymers, ferric sulfate, ferric chloride and lime.

Chlorine is often used to minimize odors from sedimentation tanks and in the final effluent as a disinfectant.

U.S. Pat. No. 5,248,416 (Howard) discloses a sewage treatment system which presents a main flow line and a recirculating line, the former for floc which has appreciated in size due to the addition of a polymer and to passage through an area of agitation/turbulence, and the latter for the return of small sized floc to the agitator/turbulence area for size increase. The passageways of the system include movable flaps which serve recirculation purposes, and a ledge or flutter for current creation and floc build-up. Raw liquid sewage enters the system, whereas the outlet leads to a belt press and/or a dry bed to cake the resulting sludge. More specifically, the apparatus for flocculating fluids containing suspended solids comprises conduit means for conducting the fluid to an outlet in the conduit means. There is means introducing a flock-producing agent into the fluid in the conduit means, a vertical drop in the conduit means downstream from the means introducing the flock-producing agent, and a movable mounted ledge means in the vertical drop which serves to increase turbulence and to increase the size of accumulating floc in the fluid. There is a vertical rise in said conduit means, downstream from the vertical drop leading to the outlet. The conduit means includes means connecting the vertical drop to the vertical rise, and there are circulation passageway means connecting the vertical rise to the vertical drop for recirculating smaller size flock to the vertical drop.

In Howard, it is said that a particular feature is that no mixer equipment is required. Polymers are injected into the raw sewage, causing water to separate from the raw sewage during the procedure, resulting in floc build-up. The latter is caused when the polymers begin dissolving with the result that a film of concentrated polymer solution builds up about the polymer particles, forming aggregates or agglomerations, identified as “flocks”. Turbulence is a key factor, where such is said to be accomplished through a ledge (which flutters) located in the vertical drop conduit and a series of movable flaps disposed within the recirculating conduit. The singular stated purpose of the Howard scheme is to create flock, i.e., solids with a minimum of water content, through separation. Restated otherwise, the Howard scheme, through turbulence or tumbler-mixer action, is said to create additional floc (of a larger size) which goes to output, whereas smaller floc is caused to recirculate said increase, thereby, in size for repeated passage to output.

### SUMMARY

An object of the present disclosure is to overcome the above-mentioned disadvantages and problems of the prior art sewage dewatering treatment processes. Another object of the of the present disclosure is to provide various process-schemes and equipment whereby the size and/or number of sand bed(s) needed can be greatly reduced. Another object of the present disclosure is to provide process-schemes and equipment whereby the time to dewater sewage and drying the sludge is greatly reduced. A further object of the present disclosure is to provide process-schemes and equipment whereby the dried sludge obtained from dewatered sewage has a greatly reduced water content. Another object of the present disclosure is to provide various embodiments of a mixer-flocculator which can be used to flocculate particles dissolved in a liquid. Another object of the present disclosure is to provide a pneumatic deliquiding unit which can be used to remove liquid from a solution containing solid particles. Another object is to provide equipment for removing a layer of solid material in particulate form from on top of a layer of solid particulate material such as sand. Other objects and advantages of the various embodiments set out herein or are obvious herefrom to one skilled in the art having the benefit of this disclosure.

The objects and advantages of the present disclosure are achieved by the sewage dewatering treatment process of the present disclosure.

The present disclosure involves a process-scheme for dewatering sewage, usually previously subjected to primary treatment, to obtain dried sludge. Solids are dissolved, suspended, etc., in the liquid sewage. The process includes: (a) mixing the sewage with a coagulant or flocculant aid; (b) mixing and flocculating the sewage from step (a) at conditions which involve extensive mixing turbulence of the sewage and whereby part of the sewage is recycled so as to be again subjected to such mixing and flocculating, flocks being formed from the solid particles in the sewage; (c) chemically adjusting the pH of the sewage from step (b) into the basic pH range or to a higher basic pH; (d) applying the sewage from step (c) to a sand bed whereby the flocculated solids in the sewage from step (c) are separated from the liquid in sewage from step (c), by collecting on the top of the sand bed, and drying the flocculated solids located on the top of the sand bed; and (e) removing the dried flocculated solids from the top of the sand bed. The sewage is usually supplied to step (a) under sufficient pressure/head (by means of a pump or line pressure) to travel completely through the process sequence without the need for an auxiliary pump(s) can be used if desired.

Dewatering sludge at wastewater treatment plants has traditionally been a major operational concern. Most large operations use mechanical filter presses to efficiently dewater their sludge. For smaller operations this equipment is too expensive and too large for their needs. Therefore, small facilities rely on said filter drying beds for sludge dewatering. This is an excellent method to process sludge; however, most beds were designed without inline dewatering (liquid-solid-separation) or an easy and automated way to remove dried sludge. Expensive time-consuming manual labor has been a tremendous burden to plant operation. The process of the present disclosure and equipment solves the old sludge bed problems. With simple and easy modifications of existing beds, old non-productive beds can be upgraded to good dewatering devices. The process and equipment of the present disclosure allows any wastewater treatment plants to change their sludge build-up problem to a modern and cost effective method to dewater, dry and remove sludge.

The process of the present disclosure also includes an optional step of dewatering the sewage using an inline pneumatic dewatering tube between steps (a) and (b) or (b) and (c) or (c) and (d), or before step (a). Use of the vertically-situated pneumatic dewatering device or tube involves conducting the sewage into the central tube-shaped filter where solids in the sewage are caught on the filter and some of the water in the sewage passes through the filter. Air under pressure is blown against the outer surface of the filter to dislodge the solids collected on the inner surface of the filter. The blowing air sources are alternated in on-off sequences in order to continuously provide regions of the filter for the water to come through unimpeded by blowing pressurized air. The thickened or concentrated sewage passes on to the next process step or operation.

The present disclosure also involves the processes for dewatering primary-treated sewage which comprised (1) above-noted steps (a), (b) and (c), or (2) above-noted steps (a) and (b), or (3) above-noted steps (b) and (c), or (4) above-noted step (b).

The first step/stage in the process-scheme of the present disclosure uses an inline polymer mixing-feeding (injection) system to incorporate activated polymer into the sewage flow line. The inline polymer preparation system eliminates this need for batching tanks, mixers and polymer transfer pumps. The inline polymer system can be a conventional one or preferably is the inline polymer mixing-feeding system of the present disclosure. The inline polymer system (chemical pump) of the present disclosure activates precise amounts of neat polymer and water, then meters the fully activated stock solution to the point of use without the need of transfer pumps. The benefits achieved by the inline polymer system include:
(A) Fully automated—any polymer—any application;
(B) Full polymer activation and little or no waste;
(C) Reduces labor and maintenance costs;
(D) Saves space—is portable; and
(E) Simplifies operation and improves safety.

The polymer mixing-feeding (injecting) system is an integrated equipment package which automatically meters, activates, dilutes and feeds liquid polymer and water. Concentrated polymer and water are blended in a complete high energy chamber.

The prepared solution (neat polymer and water) exits the original chamber through the top of the vessel. It shall then re-enters an outer retention chamber and exits the chamber at the bottom of the vessel. A round access plate is fabricated in the bottom of the primary chamber for repair and service. The chamber can be constructed of polyvinyl chlorides, stainless steel or any other suitable material. The polymer is injected into the chamber through a tube passed through the top of the chamber. The tube is designed to be adjustable in length giving variations in depth or placing the polymer closer to the aspirator or mixing energy. At the end of the tube, a spring loaded check valve allows polymer to spray into the mixing area in a thin filming process. Energy for polymer activation is created by ⅝ inch or any size stainless steel hollow shaft which at the end of the shaft is a polyvinyl chloride or stainless steel 4-way aspirator. Turning at 3,450 rpm a tremendous vacuum occurs drawing free air down the shaft into the chamber. This process causes high energy mixing. The stainless steel shaft is driven by a hollow core motor. The system activates the polymer and meters the activated polymer—water solution to the point of use without the need of transfer pumps.

The motor and shaft are attached by a coupler. The ⅝ inch or any size shaft with aspirator is placed inside the chamber and that chamber is made water tight with exterior mechanical seals. Inline check and ball valves are installed on the top or inlet side of the motor. These valves can regulate the amount of air passed through the shaft to the mixing chamber. The one way directional flow check valve is used to prevent liquid from exiting through the aspirator and shaft when the motor is in the off position. The mixer has a brass solenoid valve for on/off control of dilution water supply, and a rotameter-type flow indicator equipped with integral rate-adjusting valve. The flow indicator is machined acrylic and has valve stop and guided float. Water flow rate is adjustable 0 to 500 USGPH. Water supply input and stock solution output fittings are 0 to 500 FNPT. The drive motor of the unit is powered by a 2500 watt generator producing 120 V-15 amps. The generator is mounted to the trailer and becomes a permanent fixture of the transportable system.

The polymer is an emulsification of long chain organic polymer in oil. The water and mixing opens up or uncoils the polymer to expose charge sites in the polymer chain.

Coagulants or flocculants, such as, alum, ferric sulfate, ferric sulfate, ferric chloride and lime, can be used in place of the activated polymer in the sewage flow line to coagulate or flocculate the solids in the sewage. These coagulants or flocculants cause formation of an insoluble precipitate which adsorbs colloidal and suspended solids.

The second step/stage in the process-scheme of the present disclosure uses an inline mixing flocculator. A inline mixing-flocculating device is used to enhance the chemically induced liquid-solids separation in the sludge dewatering process utilized at most wastewater treatment plants. The flocculator is used in any type of mechanical dewatering scheme that uses a chemical as a coagulant or flocculant aid. The overall output and efficiency of the dewatering process is greatly increased by the thoroughness of the flocculating process. Prior art sludge production normally is 14,000 to 16,000 gallons of dewatered sludge per gallon of polymer; the mixer-flocculator unit of the present disclosure provides a reduction of 40 to 60 percent in polymer consumption. The benefits achieved by the inline mixing-flocculating device include:
(A) Increases sludge production;
(B) Decreases polymer usage;
(C) Increases drying bed holding capacity; and
(D) Decreases sludge drying time.

The prepared activated polymer exits the polymer preparation system and is passed into the mixer-flocculator unit. Preferably, the mixer-flocculator unit has multiple injector ports at the influent end of the mixer through which the activated polymer solution can be injected into the liquid-sludge slurry flow stream. The activated polymer and sludge is quickly yet gently mixed by baffling energy dispersing action. The mixing action promotes large floc growth. A portion of the flocculated sludge is re-circulated into the influent stream by a pressure drop zone to advance and increase the efficiency of the mixing-flocculating process.

The mixer-flocculator unit includes, in the down section above the recycle pipe, an adjustable, nonflexible baffleplate which is positioned at an angle. The adjustment can be controlled by hand adjustment means or electrically operated means. The baffleplate restricts the flow in the down pipe by about 50 to about 80 percent, thus increasing the original flow velocity by as much as 600 percent. With a lower sewage flow rate, a thinner throat is usually used; with a higher flow rate, normally a wider throat is provided with the adjustable baffle plate. Then, the pattern of flow is fanned in one direction. Thereafter, it is oppositely directed and fanned by a fixed baffle which restricts about 40 percent of the vessel's size. Then, the flow is directed into a 45 degree round angle causing the flow to turn and pass under and over and under fixed baffles in a serpentine flow pattern, which is reducing the vessel's velocity. The flow, then, enters a 45 degree round angle which causes the flow to move in a spiraling pattern which, then, comes in contact with a fixed baffle. As the flow exits the mixer-flocculator unit, it passes a horizontal pipe which causes a portion of the flow to divert through this line by the pressure drop caused by the adjustable inlet baffle. The bypass velocity may be increased if the size of the pipe is increased and with baffleplate adjustments.

As the liquid/solids content exits the inline mixer-flocculator, an electronic driven diaphragm pump or gear driven pump pumps liquid caustic into the discharge line of the mixer-flocculating system.

Benefits of use of the mixer-flocculator system described herein are numerous. The better the mixing, the better the flocculation. It is a new type of in-line mixing-flocculating system used to enhance the chemically induced liquid-solids separation in the sludge dewatering process utilized at most wastewater treatment plants. The mixer is capable of being utilized in any type of mechanical dewatering scheme which uses a chemical as a coagulant or flocculant aid. Typically, polymers are used at most wastewater treatment plants and are fully activated prior to being injected into the sludge slurry. The instant mixing-flocculating system performs the task of mixing the activated polymer solution with the sludge more rapidly and effectively because of a cascading “waterfall” flow pattern with strategically placed baffleplate, baffles and a baffled recirculating line. The mixer can be used in plants using sand drying beds, belt filter presses or centrifuges for partial dewatering of the sludge-slurry. The mixing-flocculating system shall be capable of increasing the overall output and efficiency of the dewatering process. A summary of the benefits of the use of the mixer-flocculator unit would include: increased sludge production, decreased polymer usage, increased drying bed holding capacity, decreased sludge drying time and a unit which will not clog and has multiple clean out ports.

The mixing-flocculating system shall consist of a single manufactured mixing-flocculating device capable of providing a rapid mix of the activated polymer and sludge slurry followed by a detention chamber of sufficient volume to provide enhancement of floc growth within a single unit. The device shall provide for partial re-circulation of previously flocculated sludge into the influent sludge slurry stream. The mixing-flocculating device shall be a controlled reduced velocity type.

The device preferably fabricated primarily utilizing corrosion free polyvinyl chloride components or other art suitable material such as stainless steel. The device does not have any mechanically moving parts (except for the adjustable baffleplate) and is designed to require minimum maintenance. The mixing device also is designed to minimize clogging and can be self-regulating or manual or electrically driven, regardless of flow, sludge characteristic or polymer dosage. Model RF8 is rated at 0 to 700 gallons per minute. Model RF6 is rated at 0 to 200 gallons per minute.

The mixing-flocculating system is a single manufactured mixing-flocculating device capable of providing a rapid mix of the activated polymer and sludge slurry followed by a detention chamber of sufficient volume to provide enhancement of floc growth within a single unit. The device provides for partial recirculation of previously flocculated sludge into the influent sludge slurry stream. The mixing-flocculating device is a reduced velocity type. The system is an inline mixing-flocculating device used to enhance the chemically induced liquid-solids separation in the sludge dewatering process utilized at most wastewater treatment plants. The mixing device is capable of being utilized in any type of mechanical dewatering scheme that uses a chemical as a coagulant or flocculant aid. The system performs the task of mixing activated polymer with a ½ to 8 percent solids liquid-sludge slurry rapidly and effectively. The system performs effectively in plants using sand drying beds, belt filter presses or centrifuges for partial dewatering of the sludge slurry. The mixing-flocculating system is capable of increasing the overall output and efficiency of the dewatering process. The system has multiple injector ports at the influent end of the mixer through which the activated polymer solution can be injected into the liquid-sludge slurry flow stream. The activated polymer and sludge are quickly but gently mixed by a tumbling, cascading, energy dispersing action. The mixing action promotes large rapid floc growth. A portion of the flocculated sludge is circulated back into the influent stream to advance and increase the efficiency of the mixing-flocculating process.

The third step/stage in the process-scheme of the present disclosure is a chemical induced pH adjustment of the sewage exiting the mixer-flocculating system. Liquid caustic, lime or other suitable base is injected into the discharge side of the mixer-flocculator unit and the temperature of the water to the inline polymer system is increased, thereby increasing the liquid/solids pH balance.

As the liquid/solids content exits the inline mixer-flocculator unit, an electronic driven diaphragm pump or gear driven pump pumps liquid caustic or lime into the discharge line of the flocculator-mixer unit. The pH of the sludge is increased to 12 by the chemical. The pH of the sludge will remain at 12 for 72 hours, and, during this period of time, the temperature will reach 52.degree. C. and will remain at that temperature for at least 12 hours. At the end of the 72 hour period during which the pH of the sludge is above 12, the sludge can then be air dried to achieve a percent solids of greater than 50 percent. The liquid caustic or lime pump is present on the transportable dewatering trailer with the mixer-flocculating system and the polymer feed system and, thus, is easily transported.

The benefits achieved by this third step/stage include:
(A) Federal 503 Regulations are met;
(B) expensive sludge handling procedures are hereby deleted; and
(C) expensive ovens or automated lime distribution systems are not used.

The fourth step/stage in the process-scheme of the present disclosure uses a sand (grid) cell in a sand bed used for dewatering sludge. The sand-cell is grid used to stabilize filtration media in any new or existing sand drying bed. It is preferably manufactured of heavy-duty polyethylene. Preferably the sand grid is honeycomb or similar shaped. The fixed media (i.e., grid) is best installed in the filtration sand about six inches below the surface. Under load, the sand-cell generates powerful lateral confinement forces and sand-to-cell or stone-to-cell frictions. This process creates a bridging with high flexural strength and stiffness. The sand-cell greatly enhances the dewatering process. Plant operators can drive an end or front loader or tractor over the entire bed thereby significantly reducing cleaning time and eliminating expensive manual labor. Surface and subsurface bed stabilization is achieved using the grid of the present disclosure. This allows for 100 percent maneuverability of equipment, eliminates surface and subsurface compaction of the sand media and produces an excellent drainage environment. 100 percent saturation and drainage within about 10 minutes from start to pouring of the sewage results from the use of the grid. The benefits achieved by the sand-cell include:
(A) Directly supports front-end loaders or tractors allowing them to drive directly on the sludge drying bed without destroying the integrity of the filtration sand;
(B) Prevents lateral slippage or shear of the filtration media (grid);
(C) Reduction in filtration media replacement costs;
(D) Loading and cleaning time is significantly reduced;
(E) Uses standard washed sand or “P” gravel for rapid dewatering versus expensive, conventional drying bed materials;
(F) Square foot installation cost reduced by 94 percent over fixed media system; and
(G) Total maintenance costs are reduced by more than 75 percent.

This step of the present disclosure involves use of a sand-cell media to stabilize filtration sand/media in any new or existing sand drying bed (best constructed of concrete).

A standard sand-cell section may have nominal dimensions of eight feet wide by twenty feet long by six inches deep. However, a standard sand-cell section can have any length, width and height to fully fit into the dimensions of the sand cell in case. All of the individual sand-cells forming a sand-cell section, generally, are uniform in shape and size. Preferably, the individual sand-cells are about 6 inches wide, 6 inches long, about 6 inches deep, hexagonal in shape and, together, form a honeycomb. The honeycomb is one of the strongest, yet lightest, shapes found in nature. A standard sand-cell section can be made from high-density polyethylene plastic, any other suitable plastic or resin, stainless steel, fiberglass, concrete, wood, or any other suitable metal or material, or any form of fabricated steel, preferably high-density polyethylene plastic.

The sand-cell media is advantageously installed in the filtration sand or stone with its top surface most preferably about six inches, preferably not more than 12 inches or less than 2 inches, below its surface of the sand. Under load, the sand-cell media generates powerful lateral confinement forces and stone or sand to cell frictions. This process creates a bridging with high flexural strength and stiffness.

The benefits of using sand-cell media are numerous. A subsurface which includes sand-cell media does not compact which allows the free water to pass quickly through the media. The high flexural strength and stiffness of a subsurface which includes sand-cell media allows equipment such as end loaders to drive directly onto the entire sludge drying bed without destroying the integrity of the filtration sand. This, in turn, significantly reduces the loading and cleaning time, and eliminates expensive manual labor. Other benefits of using the sand-cell media described herein include: lateral slippage or shear of the filtration media is prevented; filtration media replacement costs are reduced; economical standard washed sand or “P” gravel for rapid dewatering can be used (as opposed to conventional drying bed materials); square foot installation costs are reduced by ninety-four percent over the fixed media system; and total maintenance costs are reduced by more than seventy-five percent.

The fourth step of the present disclosure includes an inline mixing in a mixer-flocculator unit (which is part of a mixer-flocculating system) on a trailer. The purpose of having the mixer-flocculating system on a trailer is the ability to transport a complete dewatering system to a site to dewater sludge for drying bed application. In general, this sort of equipment should be transportable to prevent it from freezing and being damaged when exposed to the elements. Permanent installation of this sort of equipment in adjacent buildings is not suitable, because formed floc will separate and self-destruct if it (in sludge) is pumped or travels even as little as a few hundred feet. In contrast, the mixer-flocculating system on a trailer is designed to properly activate the polymer and go through the flocculation process for immediate use at the point of application. The present disclosure includes a complete flocculation system (including inline flocculation, a polymer feed system, a liquid caustic pump and all accessories) on a heavy duty utility trailer.

The fifth step/stage in the process of the present disclosure uses a sludge retriever to separate the dried sludge layer from the sand in the sand bed. The sludge retriever is designed to fit any adequately rated (front-end) loader and is powered by the hydraulic system of the loader. Easily operated by one person, the retriever's rotary drum of the efficiently breaks up (chops) solid waste and propels it into a hopper. The sludge is chopped into very small granular particles, enhancing transportation and handling cost. The unique combing action of the rotating drum (preferably having 3-inch adjustable tines) not only removes sludge without significantly disturbing the filtering sand, it also levels the bed surface to promote uniform drying. Each bucketload of sludge removed by the sludge retriever usually will only yield an insignificant amount of sand for precision sludge clean-up. The sludge retriever (automated) makes sludge removal and drying bed preparation a one-man, one-machine operation. It also levels and aerates the sand bed for the next pouring of sewage into the sand bed.

The sludge removal attachment is capable of removing dried wastewater sludge from sand drying beds. The implement is also capable of being attached to the front end loader. The mechanism has, for example, a two cubic yard bucket, constructed of ¼ inch steel, and a shaft-type rotary drum having multiple three inch tines. The unit is furnished with an expanded steel cover for the rotor and bucket. Rotor end plates are ½ inch steel minimum. The rotary action of the drum accomplishes several functions. First, it removes the sludge layer. Second, it simultaneously levels the surface of the drying bed. Third, by reversing the direction of the rotary drum, the sand bed can be aerated to a depth of three inches. Basically, sludge is removed by passing the unit over the drying bed and sweeping up the dried sludge.

Typical specifications are as follows: The overall width of the mechanism best not exceed 82 inch and the working width best not exceed 74 inch. The drive motor can best be 8 HP minimum and bi-directional. The drive chain should be #60 HD and the unit should be furnished with a closed metal cover for the chain drive. Hydraulic requirements for the unit should be 9 to 14 GPM at 1800 to 2200 pounds per square inch (PSI). The total weight can be 1000 pounds. The rotor construction can be shaft type with multi 3″ tines. The hydraulic drive motor can be bi-directional 8-10 HP. The drive chain can be #60 HD. The rated capacity can be ¾ yds. light material. The rotor adjustment can be cam type 1″-3″.

Alternatively, the sludge removal attachment (retriever) is capable of removing air-dried wastewater sludge from the sand bed. The unit is a bucket or scoop type device. Sludge is removed by passing the unit over the drying bed and scooping up the dried sludge.

Safety features typically include: an expanded metal cover for the rotor and bucket; a metal cover for the chain drive; ⅜″ steel rotor support; and pinch points identified.

The benefits achieved by the sludge retriever include:
(A) Ending expensive or greatly reducing manual labor;
(B) Sand removal is minimal;
(C) Leveling bed surface to promote uniform drying;
(D) Aeration of the sand; and
(E) One-man, one-machine operation.

The optional sixth step/stage in the process of the present disclosure uses a sewage thickening or concentration unit which is a pneumatic dewatering device or tube. Liquid can be removed from the sewage by passing the liquid/solid through a screen causing liquid discharge. The screen is constantly cleaned by air injection. This process can be repeated over and over producing a true inline thickening process, that is the concentration of solids in the flowing sewage. The inline sewage dewatering device can be used before the first step in the process of the present disclosure or between the first and second steps or the second and third steps or the third and fourth steps of the process.

Besides the dewatering of sewage, the pneumatic dewatering device or tube can be used to concentrate or deliquid (or dewater) solutions of any liquid containing solids. The solutions which can be concentrated can be, for example, in the chemical, pharmaceutical, mining, paper making, etc., industries. The device is useful with processes where influents, effluents, liquid bylines, etc., need to have the solids content increased.

Basically, in the dewatering process of the present disclosure, the inline pneumatic dewatering tube allows part of the liquid in the flowing sewage to exit the side of the vessel through a reinforced membrane wall. As the sewage flow passes through the vessel in a vertical direction, static head occurs. Liquid will exit through the membrane wall until it clogs. To prevent this from happening, air nozzles spray on every square inch of the wall in alternating patterns. The result is a cleaning and pulsing process causing the liquid/solid content to move in and out of contact with the wall. Air to the system is supplied by a compressor or other means. The outer hub (common air supply) is fabricated in ringed cells starting at the bottom and are evenly spaced to the top of the hub. These cells maintain a specified PSI due to inlet and outlet check valves. Ball valves can regulate the amount of air passed to and through each cell. Liquid exiting the membrane wall will free fall into the center between the wall and hub and exit the system. The discharging of liquid can continue in series to obtain the desired thickening of solids.

The benefits achieved by the sludge thickener include: that this extraction process is non-mechanical; that the inline pneumatic dewatering tube will not clog; and the inline thickening process.

The present disclosure also includes the polymer mixing-feeding device of the present disclosure.

The present disclosure further includes the mixing-flocculating system of the present disclosure. Such apparatus for mixing and flocculating fluids containing suspended solids includes conduit means for conducting the fluid to an outlet in the conduit means, a vertical drop section in the conduit means, a horizontal section in the conduit means extending from the vertical drop section, a vertical rise section in the conduit means extending from the horizontal section, a horizontal recycle section in said conduit means extending from said vertical rise section to said vertical drop section. A movable, nonflexible baffle plate is pivotally mounted on one end in the vertical drop section at or near the top portion of the intersection between the vertical drop section and the horizontal recycle section. The pivotal, movable baffle plate is adopted to constrict in a variable manner, at such location, the internal diameter of the vertical drop section. A set of at least one nonflexible baffle located on the bottom internal surface of and a set of at least one nonflexible baffle located on the top internal surface of the horizontal section. The sets of nonflexible baffles are positioned in relation to each other so as to be in alternating sequence. Preferably at least one nonflexible baffle is located on the top internal surface of the horizontal recycle section. Preferably a nonflexible baffle is located on the internal wall of the vertical rise section opposite of the horizontal recycle section so as to be at or near the lower portion of the intersection of the vertical rise section and the horizontal recycle section. Preferably a nonflexible baffle is located on the internal wall of the vertical drop section opposite of and below the intersection of the vertical drop section.

Also preferably means for introducing a floc producing agent into the fluid or liquid in the conduit means upstream of the vertical drop section. Preferably the means introducing a floc-producing agent comprises a plurality of injector jets spaced around the periphery of the conduit means upstream from the vertical drop section.

The present disclosure also includes a combination of the mixing flocculating device of the present disclosure mounted on the bed of a truck or on a trailer. A polymer mixing system and a means for adjusting the pH of the sewage are also preferably mounted on the trailer. The polymer mixing system is used for preparing an activated polymer solution and injecting the activated polymer solution into the inflow line of the mixing-flocculating device. A generator can also be mounted on the trailer to provide electrical power to operate the polymer mixing system and the means for adjusting the pH of the sewage.

The present disclosure also involves an improved sand cell for the dewatering of sewage composed of water and particulate solids. A grid having open vertical passageways is positioned horizontally in the sand layer in the sand cell. Preferably the grid has a honeycomb or similar shape. Preferably the grid is composed of high density polyethylene plastic.

The present disclosure also includes the pneumatic dewatering (deliquiding) device or tube of the present disclosure.

The pneumatic deliquiding tube, which is adopted for use in the vertical orientation of the central axis of said deliquiding tube, includes a cylindrical shell, a cylindrical tubular filter positioned inside of the cylindrical shell, and two cylindrical blocks, each of which is affixed on the outer portion of one end to an end of the cylindrical shell and on the inner portion to of such end to the corresponding end of the cylindrical shell. The blocks have a central passageway which corresponds to the interior of the cylindrical filter. There is a plurality of passageways in the cylindrical shell which traverse entirely around said cylindrical shell. There are at least two manifold means oriented parallel or at an acute angle to the central axis of the deliquifying tube. The manifolds are located external to the cylindrical shell. Each of the manifolds communicates by means of conduits to every other of the passageways (that is, in an alternative sequence). At least one of the manifolds communicates with passageways other than the passageways with which at least one other manifold communicates. A plurality of air jets is located on the inner wall of the cylindrical wall. Each of the passageways has at least two of the air jets communicating therewith. The manifolds are adopted to be connected to a source of pressurized gas. There is means for controlling the flow of pressurized gas so that the pressurized gas is delivered in short phases or bursts in a manner alternating between the manifolds which communicate with different alternative arrays of the passageways. The pressurized air exits from the air jets against the external surface of the cylindrical filter in the alternating manner. At least one channel is in at least one of the blocks. Such channel communicates from the space between the cylindrical shell and the cylindrical shell to the exterior. The pneumatic deliquiding tank can be constructed so that the cylindrical shell and the cylindrical filter is segmented with one of the blocks between each of the segments—see FIG. 12.

The sludge thickener has the ability to dewater (deliquid) any solution containing solids. The device extracts liquid from a liquid/solid by passing the liquid/solid through a screen causing liquid discharge. The screen is constantly cleaned by air injection.

In one embodiment of the present disclosure, a mixing-flocculating unit is provided. The mixing-flocculating unit includes: an inlet section; an outlet section fluidly connected to the inlet section; and a bottom section and a recycling section fluidly coupled to the inlet and outlet sections; the inlet section includes a first baffle positioned upstream of the recycling section; the inlet section further includes a second baffle, the outlet section includes a baffle, the recycling section includes a plurality of baffles, and the bottom section includes a plurality of baffles.

In one embodiment, the first baffle is non-flexible and fixed to the inlet section increases the velocity of liquid flow through the inlet section. In another embodiment, the first baffle restricts a liquid flow through the inlet section by between 50% and 80%. In another embodiment, the first baffle of the inlet section restricts a liquid flow through the inlet section by about 50%. In another embodiment, the baffles for the inlet section, the outlet section, the recycling section, and the bottom section are non-flexible and fixed. In another embodiment, the recycling section has a diameter that is smaller than diameters of the inlet section, the outlet section, and the bottom section such that a venturi effect is created to draw liquid flow into the recycling section.

In another embodiment of the present disclosure, a mixing-flocculating unit is provided. The mixing-flocculating unit includes: an inlet section; an outlet section fluidly connected to the inlet section; a bottom section and a recycling section fluidly coupled to the inlet and outlet sections, the recycling section having a diameter smaller than diameters of the inlet section, the outlet section, and the bottom section; and a first baffle positioned in the inlet section upstream of the recycling section, the first baffle is non-flexible and fixed to the inlet section increases the velocity of liquid flow through the inlet section; wherein the inlet section includes a second baffle, the outlet section includes a baffle, the recycling section includes a plurality of baffles, and the bottom section includes a plurality of baffles.

In one embodiment, the first baffle of the inlet section is configured to increase liquid flow velocity. In another embodiment, the baffle of the outlet section is configured to reduce liquid flow velocity. In another embodiment, the plurality of baffles for the bottom section are arranged in a serpentine pattern such that liquid flow velocity is reduced. In another embodiment, the smaller diameter of the recycling portion creates a venturi effect to draw liquid flow from the outlet section into the recycling section.

In another embodiment of the present disclosure, a mixing-flocculating unit is provided. The mixing-flocculating unit includes: an inlet section coupled to a spool apparatus, the spool apparatus configured to provide for injection of gas, liquid, or combination of materials into liquid flow entering the inlet section; an outlet section fluidly connected to the inlet section; a bottom section and a recycling section fluidly coupled to the inlet and outlet sections, the recycling section having a diameter smaller than diameters of the inlet section, the outlet section, and the bottom section; and a first baffle positioned in the inlet section upstream of the recycling section; wherein the inlet section includes a second baffle, the outlet section includes a baffle, the recycling section includes a plurality of baffles, and the bottom section includes a plurality of baffles.

In one embodiment, the spool includes a plurality of tangential openings in fluid communication with a liquid gas injection line such that gas can be injected into liquid flow when entering the inlet section. In another embodiment, the smaller diameter of the recycling portion creates a venturi effect to draw liquid flow from the outlet section into the recycling section. In another embodiment, the first baffle and the second baffle of the inlet section are configured to increase liquid flow velocity. In another embodiment, the baffle of the outlet section is configured to reduce liquid flow velocity. In another embodiment, the plurality of baffles for the bottom section are arranged in a serpentine pattern such that liquid flow velocity is reduced. In another embodiment, the first baffle is non-flexible and fixed to the inlet section increases the velocity of liquid flow through the inlet section. In another embodiment, the first baffle restricts a liquid flow through the inlet section by between 50% and 80%. In another embodiment, the first baffle of the inlet section restricts a liquid flow through the inlet section by about 50%.

Modifications and changes made to this sludge treatment process can be effected without departing from the scope or spirit of the present disclosure. For example, a sand-cell media (grid) in which the shape of the individual cells does not result in a honeycomb formation may be used. Also, the embodiments of this sludge treatment process which are illustrated as follows have been shown only by way of example and should not be taken to limit the scope of the following claims.

### BRIEF DESCRIPTION OF THE DRAWINGS

In the drawings:

FIG. 1 is a schematic diagraph of the steps or stages in the process/method of the present disclosure;

FIG. 2 is a side, elevational view, partially cut-away, of the polymer mixing-feeding device of the present disclosure;

FIG. 3 is a perspective view, partially cut-away, of the apparatus for flocculating fluids containing solids, along with polymer injectors, of U.S. Pat. No. 5,248,416;

FIG. 4 is a side elevational view of the mixing-flocculating system on a trailer;

FIG. 5 is a side, cross-sectional view of the mixing-flocculating unit;

FIG. 5A is another side, cross-sectional view of a mixing-flocculating unit according to various embodiments;

FIG. 6 is a side, elevational view of the mixing-flocculating system on a trailer including a barrel, a dip tube, a motor and a control valve;

FIG. 7 is a perspective view of a vertical cross-section of the sand filter set-up of the various embodiments including a layer of sand, a sand-cell media in the sand layer, a porous (stones or pebbles) layer, non-porous pipes having holes therein and a non-porous bottom layer;

FIG. 8 is a perspective view of a vertical cross-section of the sand filter set-up of various embodiments shown in FIG. 7; having holes and a non-porous layer;

FIG. 9 is an elevational view of the sand-cell media having a honeycomb formation;

FIG. 10 is an elevational view of the sand-cell media (in honeycomb formation) and surrounding sand layer showing the forces impacting the sides of a single sand-cell when the wheel of a loader or other loading equipment is on the sand surface above it;

FIG. 11 is a side, elevational view of the sludge retriever operating on top of a sludge drying sand bed which includes sand-cell media;

FIG. 12 is a longitudinal, partial cross-sectional view of one embodiment of the pneumatic dewatering device according to various embodiments; and

FIG. 13 is a longitudinal, partial cross-sectional view of another embodiment of the pneumatic dewatering device according to various embodiments.

### DETAILED DESCRIPTION

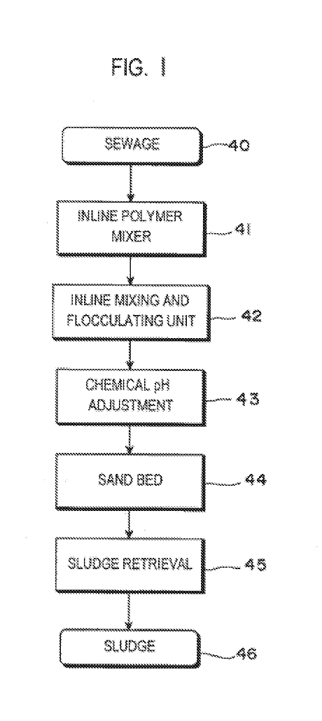

FIG. 1 describes the five step/stage process of the present disclosure described in FIG. 1. Sewage 40 is obtained from a primary sewage treatment system which is or includes a filtering step to remove large objects, grit and the like and a sedimentation tank step to remove suspended settleable solids. Activated polymer solution from inline polymer mixer 41 is injected into sewage 40 to aid in flocculation. The sewage 40 then moves into inline mixing-and-flocculating unit 42 wherein the sewage is mixed and flocculated to enhance chemically induced liquid-solids separation. The treated sewage exiting from mixing-and-flocculating unit 42 is subjected to chemical pH adjustment 43 by the addition thereto by a base such as lime or caustic (potassium hydroxide or sodium hydroxide). The pH of the sewage is adjusted into the basic pH range or to a higher basic pH. The sewage is then poured onto sand bed 44 which contains a support grid therein. The larger insoluble solids and flocks in the sewage collect on the top of sand bed 44 and the water in the sewage passes/filters through sand bed 44. Once the solids and flocks located on top of sand bed 44 dry, a layer of dried sludge pieces is obtained on top of sand bed 44. The dried sludge pieces are then removed in sludge retrieval step 45 to provide dried sludge 46.

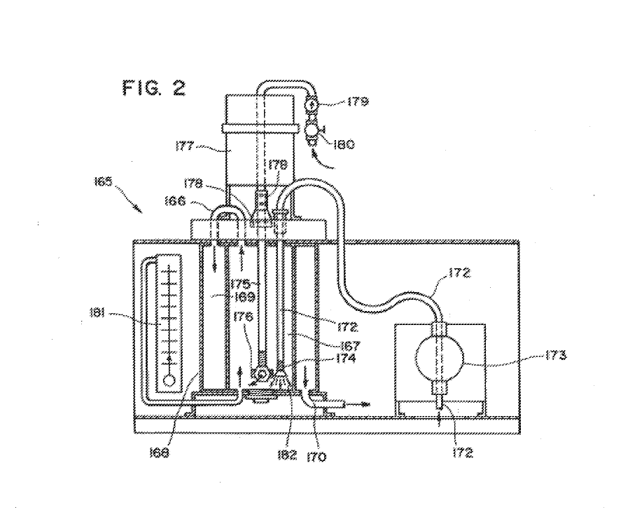

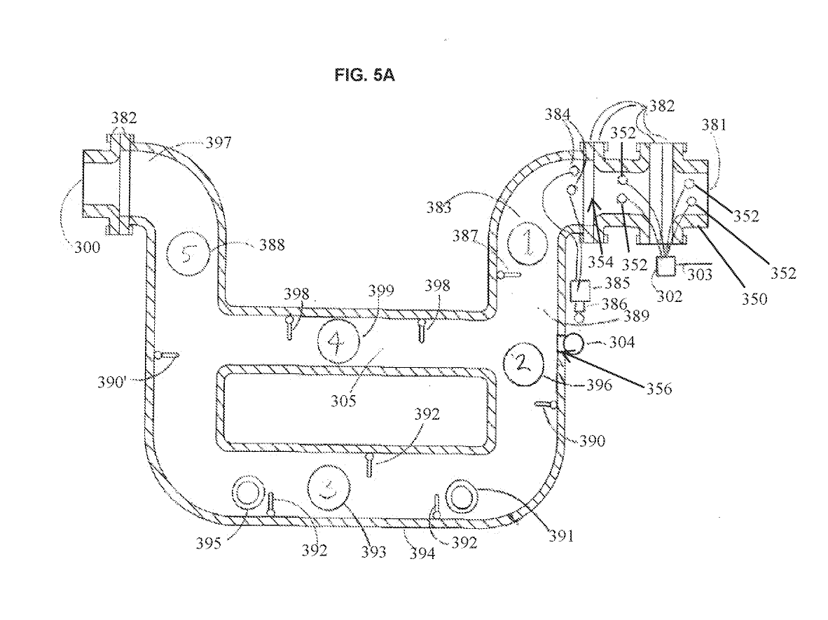

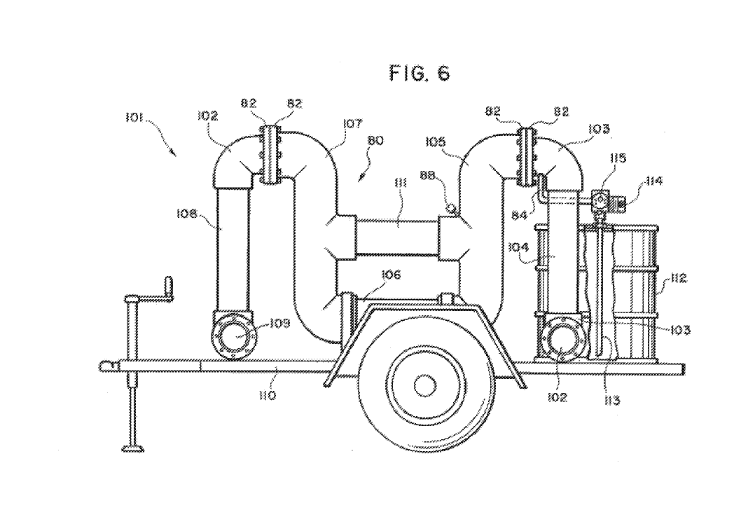

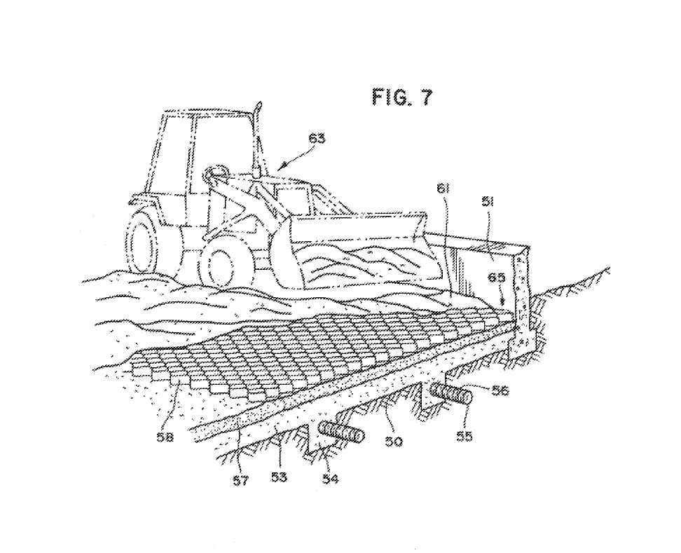

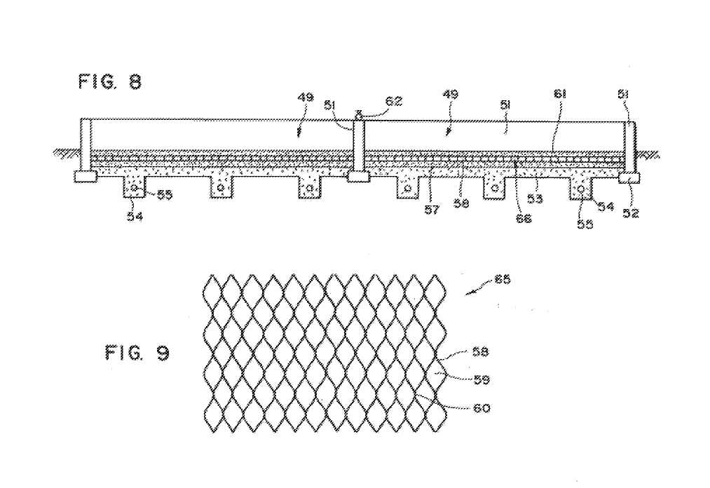

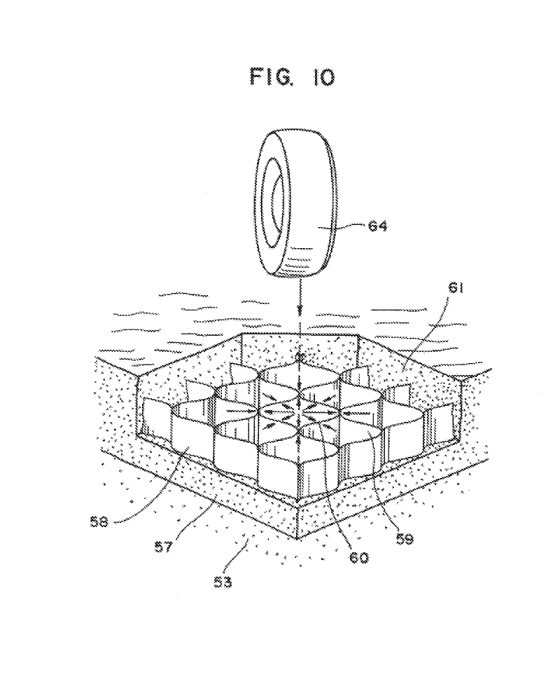

With regard to the first step of the process of the present disclosure, that is, polymer mixing and injecting device (see FIG. 1) is more fully shown in FIG. 2. The polymer mixing-feeding (injecting) (165) system is an integrated equipment package which automatically meters, activates, dilutes and feeds liquid polymer and water. (See FIGS. 2 and 6.) Concentrated polymer and water are blended in a complete high energy chamber.

The prepared solution via tube (166) exits the original chamber (167) through the top of the vessel (168). It then re-enters an outer retention chamber (169) and exits the chamber (169) via tube (170) at the bottom of the vessel to the polymer injectors. A round access plate (171) is fabricated in the bottom of the primary chamber (167) for repair and service. The chamber (167) can be constructed of polyvinyl chlorides, stainless steel or any other suitable material. Polymer from a source not shown is transported in tube (172) by means of metering pump (173). Unit (173) mixes water with the polymer. The polymer is injected into the chamber (167) through a tube (172) passed through the top of the chamber (167). The tube (172) is designed to be adjustable in length giving variations in depth or placing the polymer closer to the aspirator or mixing energy. At the end of the tube (172), a spring loaded check valve (174) allows polymer to spray into the mixing area in a thin filming process (182). Energy for polymer activation is created by a ⅝ inch or any size stainless steel hollow shaft (175) which at the end of the shaft is a polyvinyl chloride or stainless steel 4-way aspirator (176). With the aspirator turning at 3,450 rpm, a tremendous vacuum occurs drawing free air down the hollow shaft (175) into the chamber (167). This process causes high energy mixing. The stainless steel shaft (175) is driven by a hollow core motor (177). The motor (177) and shaft (175) are attached by a coupler (176). The ⅝ inch or any size shaft (177) with aspirator (176) is placed inside the chamber (176) and that chamber (176) is made water tight with exterior mechanical seals (178). Inline check (179) and ball valves (180) are installed on the top or inlet side of the motor (177). These valves (180) can regulate the amount of air passed through the hollow shaft (175) to the mixing chamber (176). The one way directional flow check valve (179) is used to prevent liquid from exiting through the aspirator (176) and shaft (175) when the motor (177) is in the off position. The mixer has a brass solenoid valve for on/off control of dilution water supply (not shown), and a rotameter-type flow indicator (181) equipped with integral rate-adjusting valve. Water is supplied to primary chamber (167) via tube (183). The flow indicator is machined acrylic and has valve stop and guided float. Water flow rate is adjustable 0 to 500 USGPH. Water supply input and stock solution output fittings are 0 to 500 FNPT. The drive motor (177) of the unit is powered by a 2500 watt generator producing 120 V-15 amps. The generator (not shown) is mounted to the trailer and becomes a permanent fixture of the transportable system.

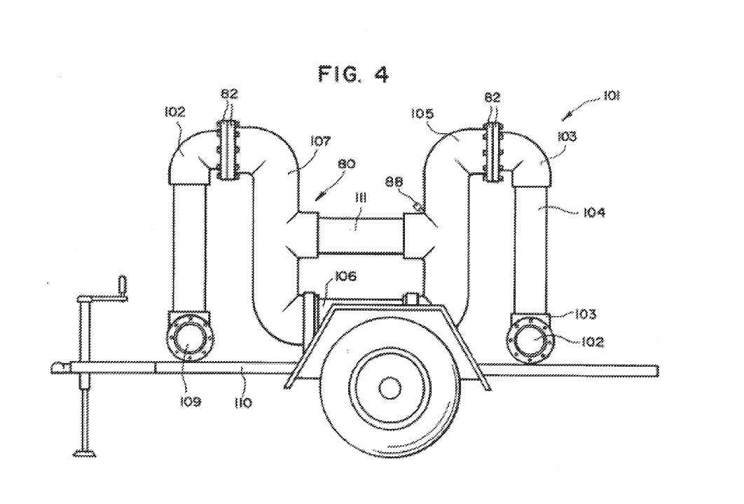

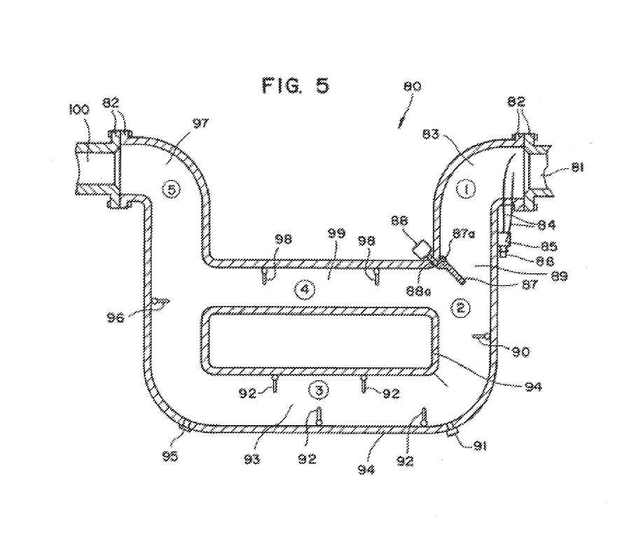

With regard to the second step of the process of the present disclosure, that is, inline mixing and flocculating (see FIG. 1), the following mixer-flocculating system is constructed: Onto the bed of a trailer (110), the mixer-flocculating system (101) is secured. (See FIG. 4.) Part of the mixer-flocculating system is a mixer-flocculator unit (80). Sewage enters pipe (102) the mixing-flocculator unit (80) through an elbow (103). The elbow (103) is attached to a vertical inlet pipe segment (104) which is, in turn, attached to another elbow (103). This latter elbow (103) has a flange (82) which is attached to a flange on the end of a downflow segment (105). The downflow segment (105) continues into a horizontal bottomflow segment (106). A recycle segment (111) contacts the downflow segment (105). An electrical control-drive unit (88) turns a threadedly adjustable rod (88a) extending through the wall of the device to contact the top of adjustable baffleplate (87). Baffleplate (87) is pivotally attached (87a) to the side of to the downflow segment (105) near the top where the downflow segment (105) and recycle segment (111) intersect. The adjustable, nonflexible baffleplate (87) is located at an angle (which can be readily changed) within the downflow segment (105). (See FIG. 5.) The electrical control-drive unit (88) can, instead, be a manual control (of the angle of the adjustable baffleplate), such as, manually turning the rod (88a). The other end of the recycle segment (111) and the other end of the bottomflow segment (106) are joined to openings in an upflow segment (107). At one end of the upflow segment (107) is a flange (82) which is attached to a flange (82a) at one end of an elbow (103). The other end of this elbow (103) is attached to a vertical, exit pipe segment (108). Attached to the other end of the vertical, exit pipe segment (108) is another elbow (103) through which the sewage exits (109).

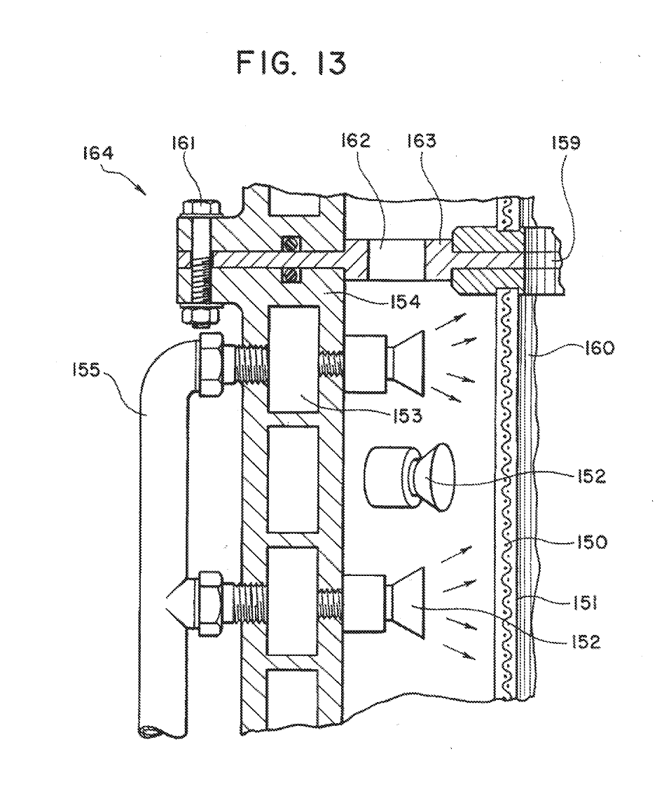

Running into the elbow (103) which is attached both to the vertical inlet pipe segment (104) and the downflow segment (105) are polymer or flocculant injection lines (84). Attached to the other end of these polymer or flocculant injection lines (84) are a manifold (85), a quick connect (86), a motor (115) and a control valve (114). (See FIG. 6.) A dip tube (113) runs from the control valve (114) into a barrel (112) resting on the trailer (110). Preferably the polymer mixing and injecting apparatus of FIG. 13 is used to provide the activated polymer solution to barrel 112.

Sewage enters an elbow (103) and runs through the vertical inlet pipe segment (104). It then passes through another elbow (103) into the downflow segment (105). As the sewage/flow passes into the downflow segment (105), it passes through a 45 degree angle. This area is called mixing zone 1 (83). As the sewage/flow runs through the downflow segment (105), it encounters an adjustable baffleplate (87), which is positioned at an angle. The adjustable baffleplate (87) restricts the vessel's flow by about 50 to about 80 percent, thus increasing the original flow velocity by as much as 600 percent. Then, the sewage/flow is fanned in one direction—towards the bottomflow segment (106). A fixed baffle (90), which restricts typically 40 percent of the vessel's size, is positioned in the downflow segment and serves to oppositely direct and fan the passing sewage/flow. The area between the adjustable baffleplate and the fixed baffle is called mixing zone 2 (89). Then, the sewage/flow is directed into a 45 degree round angle into the bottomflow segment (106). Positioned within the bottomflow segment are at least two (preferably, a number of) fixed, horizontal baffles (92), the positioning of which cause the sewage/flow to pass under and over and under these fixed, horizontal baffles (92) in a serpentine flow pattern, thereby reducing the flow velocity. This area is called mixing zone 3 (93). The sewage/flow, then, enters the upflow segment (107) in a 45 degree round angle which causes the sewage/flow to move in a spiraling pattern. Positioned in the upflow segment (107) is (at least one) fixed vertical baffle (96). Mixing zone 5 is in the exit end of upflow pipe 107 where it bends to the horizontal. Before the sewage/flow exits the mixer-flocculator unit (80), before it enters an elbow (102) and the vertical exit pipe segment (108), it passes a horizontal pipe/recycle segment (111) which causes a portion of the sewage/flow to divert through this line, because of the pressure drop caused by the adjustable inlet baffle (87) placed at an angle. The bypass velocity may be increased, if the size of the pipe is increased and with baffle adjustments. Also before the sewage/flow exits the mixer-flocculator unit (80), before it enters an elbow (102) and the vertical exit pipe segment (108), but after it passes the horizontal pipe/recycle segment (111), it passes through a 45 degree angle. This area is called mixing zone 4 (99). Recycle segment (111) has a smaller diameter than the rest of the pipes of the unit.

A drainage plug (91) is present in the downflow segment (105), close to where the sewage/flow enters the bottomflow segment (106). A flush plug (95) is present in the upflow segment (107) close to where it joins together with the bottomflow segment (106).

Model RF6 of the mixing and flocculating unit 80 is basically shown in FIG. 5. Note the two non-flexible baffles 92 located in the bottom of bottomflow segment 106. The results of tests using Model RF6 in dewatering test are given below in Table 1 and 2.

TABLE 1
MIXING ZONES
(Velocity versus feet per second)

| G.P.M. | ZONE 1 | ZONE 2 | ZONE 3 | ZONE 4 | ZONE 5 |
|---|---|---|---|---|---|
| A) 100 | 1.28 | 5.04 | 2.89 | 8.68 | 1.28 |
| B) 150 | 1.92 | 7.56 | 3.83 | 13.10 | 1.92 |
| C) 200 | 2.57 | 10.10 | 4.44 | 17.4 | 2.57 |

TABLE 2

| | | Emulsion | Polymer | Baffle Plate | | | |
|---|---|---|---|---|---|---|---|
| | Sludge | Polymer | Solution | Position | | Filtrate | Dried Sludge |
| Velocity | Con. | Conc. | Conc. | (% of | Floc Size | Conc. | (% and |
| (G.P.M.) | (% T.S.) | (Neat) | (%) | Vessel Dia) | (SML) | (% T.S.) | Time) |
| A) 100 | 2% | 55% | .25 | .70 | L | 0 | 6 hrs.-14% |
| | | | | | | | 24 hrs.-24% |
| | | | | | | | 48 hrs.-30% |
| | | | | | | | 72 hrs.-47% |
| | | | | | | | 168 hrs.-60% |
| B) 150 | 2% | 55% | .25 | .65 | L | 0 | same |
| C) 200 | 2% | 55% | .25 | .60 | M | 0 | same |

Model RF8 is similar to Model RF6 except it has a larger flow capacity and only has one nonflexible baffle 92 in the bottom of flow segment 106 (located between the two baffles 92 in the top thereof). The results of tests using Model RF8 in dewatering tests are given below in Tables 3 and 4.

TABLE 3
MIXING ZONES
(Velocity versus feet per second)

| G.P.M. | ZONE 1 | ZONE 2 | ZONE 3 | ZONE 4 | ZONE 5 |
|---|---|---|---|---|---|
| A) 200 | 1.28 | 5.04 | 2.89 | 8.68 | 1.28 |
| B) 300 | 1.92 | 7.56 | 3.83 | 13.10 | 1.92 |
| C) 400 | 2.57 | 10.10 | 4.44 | 17.4 | 2.57 |
| D) 500 | 3.31 | 12.60 | 5.55 | 21.7 | 3.21 |
| E) 600 | 3.85 | 15.10 | 6.66 | 28.0 | 3.85 |
| F) 700 | 4.49 | 17.60 | 7.77 | 30.4 | 4.49 |

TABLE 4

| | | Emulsion | Polymer | Baffle Plate | | | |
|---|---|---|---|---|---|---|---|
| | Sludge | Polymer | Solution | Position | | Filtrate | Dried Sludge |
| Velocity | Con. | Conc. | Conc. | (% of | Floc Size | Conc. | (% and |
| (G.P.M.) | (% T.S.) | (Neat) | (%) | Vessel Dia) | (SML) | (% T.S.) | Time) |
| A) 200 | 2% | 55% | .25 | .70 | L | 0 | 6 hrs.-12% |
| | | | | | | | 24 hrs.-22% |
| | | | | | | | 48 hrs.-35% |
| | | | | | | | 72 hrs.-45% |
| | | | | | | | 168 hrs.-65% |
| B) 300 | 2% | 55% | .25 | .65 | L | 0 | same |
| C) 400 | 2% | 55% | .25 | .60 | M | 0 | same |
| D) 500 | 2% | 55% | .30 | .55 | S | 0 | same |
| E) 600 | 2% | 55% | .50 | .50 | S | 0 | same |
| F) 700 | 2% | 55% | .55 | .50 | S | 0 | same |

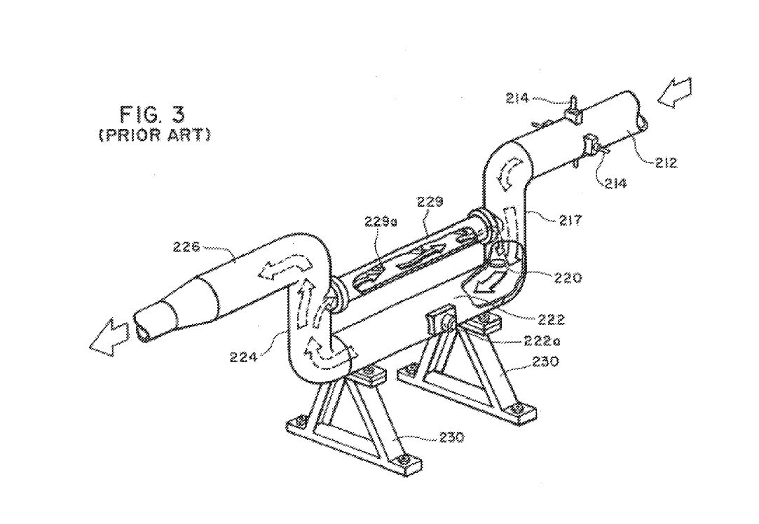

The sewage apparatus of U.S. Pat. No. 5,248,416 (Howard) is shown in FIG. 3. In the apparatus of Howard, incoming liquid containing solids and recirculated liquid containing solids and flock fills the entire apparatus, including pipe 229. The velocity going into the system is the same as that exiting the system. The path of the flow of material is down conduit 217, through bottom conduit 222, up conduit 224, and then split so as to be partly recycled through the top pie 229 and partly passed on out conduit 224, without any meaningful restrictions. Item 220 is a moveable flutter or ledge and items 229a are fabricated rubber tumblers which bend with the flow and, thus, offer little or no restrictions in the flow paths. Moveable flutter or ledge 220 is located in down flow conduit 217 at the lower intersection point of recycle conduit 229 and down flow conduit 217. Through testing of the Howard system, applicant has found that the Howard system is not very effective in achieving its stated purpose and in solving its stated prior art problem.

In contrast, the improvements of the present disclosure include a mixer-flocculator unit having an adjustable baffleplate placed at an angle to the direction of flow of the incoming sewage (containing, for example, ½ to 8 percent of solids). The baffle plate restricts the flow area in downflow pipe segment 106 just before the intersection with recycle pipe segment 111 by about 50 to about 80 percent. This cross-sectional area adjustment process can increase the original flow velocity by as much as 600 percent or more. The pattern of flow of the combination of the incoming material and the recycle material, then, is moved in one direction. Thereafter, flowing liquid is oppositely directed and fanned by a fixed, nonflexible baffle 390 which restricts 40 percent or so of the internal size (cross sectional area) of the pipe. Then, the liquid flow is directed into a 45 degree round angle which causes the liquid flow to turn and pass under and over and under fixed, nonflexible baffles 392 in a serpentine flow pattern, thereby further reducing the velocity of flow in the pipe. Thereafter, the liquid flow enters a 45 degree round angle which causes the flow to move upward in a spiraling pattern. The liquid flow, then, comes in contact with a fixed, nonflexible baffle 390′. Baffle 390′ is located across from the entrance to a side or recycle pipe. As the upward liquid flow reaches such baffle and side horizontal recycle pipe, a portion of it to divert through this line by the action of baffle 390′ and by the pressure drop caused by the adjustable inlet baffle plate in the down flow pipe segment 106. The internal diameter of recycle pipe 111 is less than the internal diameter of down flow pipe 105 or upward flow pipe 107. The bypass velocity in the recycle pipe can be increased by decreasing the size of the pipe and/or by adjusting the baffle. This recycle system allows the continued size growth of the floc.

Preferably the mixer-flocculator unit will have multiple injector ports at the influent end of the mixer, through which the activated polymer solution can be injected into the liquid-sludge slurry flow stream. The activated polymer and sludge will then be quickly but gently mixed by baffling energy dispersing action. The mixing action promotes large floc growth. A portion of the flocculated sludge, then, is re-circulated into the influent stream by a pressure drop zone to advance and increase the efficiency of the mixing-flocculating process. The device can be fabricated utilizing corrosion free polyvinyl chloride components, stainless steel, concrete, fiberglass, wood or any other suitable metal or other material. The interior baffles can be fabricated from polyvinyl chloride, stainless steel, concrete, fiberglass, wood or any other suitable metal or other material.

With regard to the third step of the process of the present disclosure, that is, a chemical induced pH adjustment of the sewage exiting the mixer-flocculating system (101), the following is included: As the liquid/solids content exits the inline m ixer-flocculator unit (80), an electronic or gear driven diaphragm pump (not shown) pumps liquid caustic or lime into the discharge line for example, 102, 108, 109, etc.) of the flocculator-mixer unit (80). The pH of the sludge is increased to 12 by the chemical additive (base). The pH of the sludge will remain at 12 for 72 hours, and, during this period of time, the temperature will reach 52.degree. C. and will remain at that temperature for at least 12 hours. At the end of the 72 hour period during which the pH of the sludge is above 12, the sludge can be air dried to achieve a percent solids of greater than 50 percent. The liquid caustic or lime pump is present on the transportable dewatering trailer (110) with the mixer-flocculating system (101) and the polymer feed system and, thus, is easily transported.

With regard to the fourth step of the process of the present disclosure (see FIG. 1), enclosure 49 contains sand bed 44. Onto a layer of non-porous material (50), e.g., concrete, a layer of porous material (53) is positioned. Porous material (53) is used as a filter media and usually stone, crushed rock, ceramic shapes, slag and plastics of 1 to 6 inches, practically 2 to 4 inches, in size are used. Stones or pebbles are preferred. At least one—usually more than one—projection of porous material (54) extends from the porous layer (53) into the layer of non-porous material (50). Embedded in each projection channels (48) in porous material (54) is at least one non-porous pipe (55) having at least one hole (56) into which liquid can drain. A layer of sand (57) is positioned above the layer of porous material (53). The sand-cell media sections (65) are positioned above this layer of sand (57). Sand is located in passageways 59 in sand cell grid (65). Above each sand-cell media section (65) is placed a layer of sand (61). This layer of sand (61) is usually, though not necessarily, at least six inches in depth.

Walls (51) surround on all four sides of an area having one or more sand-cell media sections (65)—on wall 51 is shorter to allow a front loader or the like into the enclosure. Each surrounding, dividing wall (51) extends upward from one or more footing supports (52) which are positioned, at least partially, in the layer of non-porous material (50). The top of each dividing wall (51) extends above the layer of sand (61) overlaying the sand-cell media section(s). On the top of each dividing wall (51) which runs between two enclosure areas having sand-cell media sections (65) is portable nozzle (62) which is used to pour sewage into the enclosures.

Each sand-cell media section (65) is made up of one or more sand-cells (58) having the same shape and size. Typically, the sand-cell media section is made up of honeycomb-shaped sand-cells (58) which are joined together in a honeycomb formation (i.e., each sand-cell which is not in an outer layer, where it intersects (59) another sand-cell, it intersects three other sand-cells). A channel (59) runs through the interior of each sand-cell.

Sewage is poured through the channel (62) into one or more enclosures 49 for sand beds 44. The liquid permeates the outer sand layer, flows through the sand in the channels (59) in the grid 65 in the centers of the sand-cells, permeates the layer of sand beneath the sand-cell media, and permeates the pebble layer beneath that layer, leaving the collected sludge solids to dry from the sun and air.

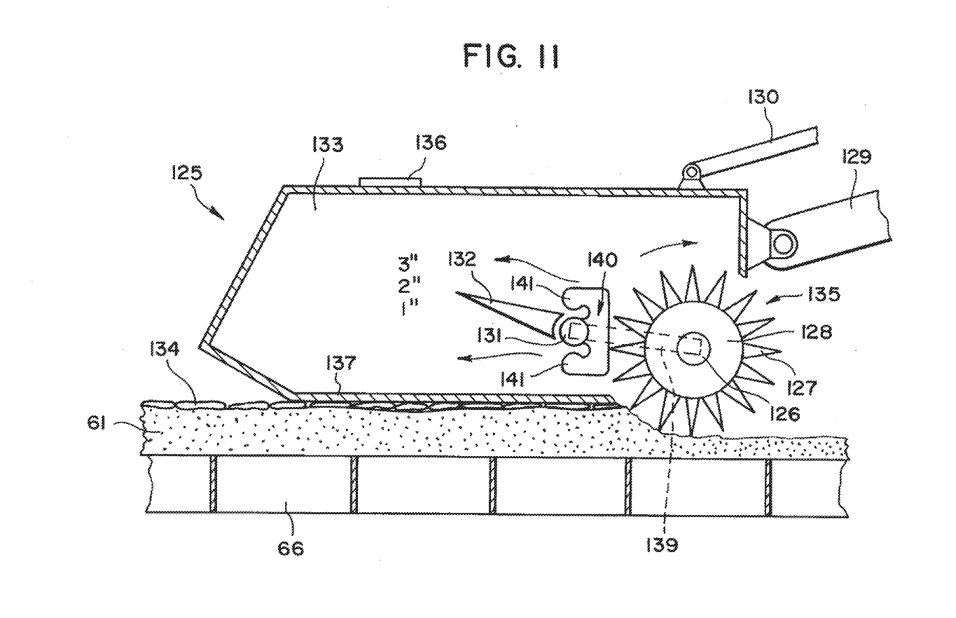

With regard to the fifth of the process of the present disclosure (see FIG. 1), a sludge retriever (125) is used to separate the dried sludge layer (134) from the sand (61) in the sand bed (44). (See FIG. 11.) An upper pivoted arm (130) is attached to a front-end loader, as is a lower pivoted arm (129). The other end of each of these pivoted arms is attached to a two cubic yard bucket/hopper (133). The lower side (137) of the bucket/hopper (133) slides along the sandbed slightly above or on the layer of dried sludge (134) being retrieved. The lower, front end (138) of this bucket/hopper (133) is upwardly slanted relative to the rest of the lower end. At the lower back end of the bucket/hopper is attached a rotary drum (135) including a shaft (126) around which a rotary (128), from which multiple raw of three inch tines/teeth (127) project, turns. As the rotary drum (135) turns (clockwise), pieces of dried sludge (134) and minimal amounts of sand (61) are tossed into the bucket/hopper (133). An arm (132) is attached to a ball pivot (131) which has a short arm (139) welded onto the end of ball joint (131). Ball joint (131) is moved up or down in vertical slot (140) in the side of retriever (125) and moved and bolted into one of the three short horizontal slots (141), whereby shaft (126) is moved up or down to the desired position. This arrangement (not shown) is repeated on the other side of the retriever (125). In this manner, the height position of shaft (126) can be adjusted and accordingly the distance that vanes (127) extend below lower side (137) of retriever (125). As typically shown in FIG. 11, vane (127) extension levels of 1 inch, 2 inches and 3 inches are indicated by the marks “1”, “2” and “3”, respectively. The one inch level is usually used to chop up the dried sludge. The 2 inch level is shown in operation in FIG. 11. The three inch level is used, when the rotation direction of rotary (128) is reversed, to aerate the sand after the dried sludge has been removed. Air flow grill or filter (136) is located in the top surface of bucket (133) near its front.

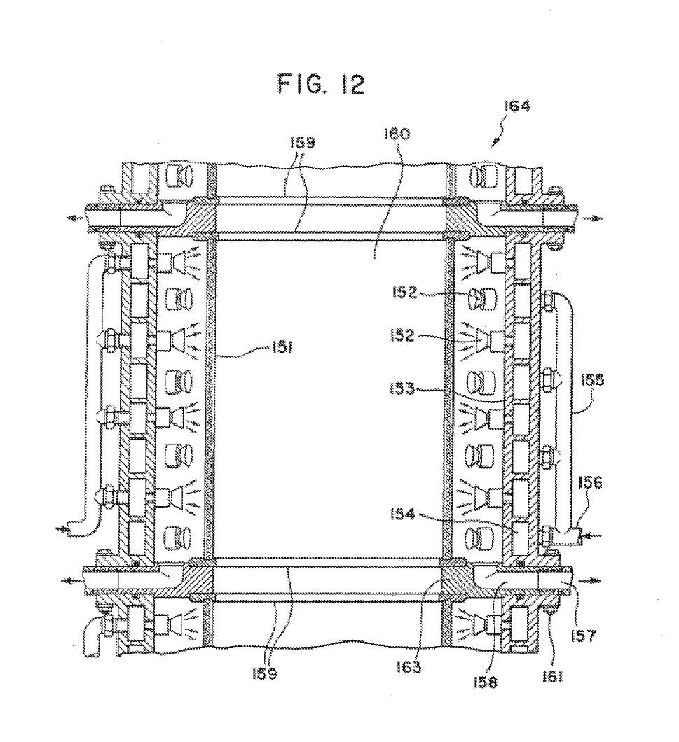

With regard to the optional (sixth) step of the present disclosure, that is, dewatering the sewage using an inline vertically-oriented, pneumatic dewatering tube (164) between steps (a) and (b) or (b) and (c) or (c) and (d), or before step (a), see FIG. 12. A cylindrical-shaped screen filter (150) reinforcing ribs (151), usually composed of stainless steel. Rim rings (159) connect the circular-shaped screen filter (150) with a rim block (163). Running through the rim (163) are water exit passageways (158). The flanged ends of cylindrical shell (153) are bolted (161) together with rim block (163). In this shell (153) are peripheral air chambers (154) which traverse the entire circumference of shell (153). One end of the water exit passageways (158) opens into the area in between the shell (153) and filter (151). Positioned in this area are staggered, pressurized air jets (152) communicating with air chambers (154). Manifolds (155) are positioned outside of shell (153) and communicate with every other circular air chamber (154), and hence to every other bank of pressurized air jets (152).

Use of the pneumatic dewatering device or tube (164) involves conducting (160) the sewage into the central tube-shaped filter where solids in the sewage are caught on the filter (150) and part of the water in the sewage passes through the filter (150). Air under pressure is blown from staggered, high pressure air jets (152) against the outer surface of the filter (150) to dislodge the solids collected on the inner surface of the filter (150). The blowing air jets (152) are alternated in on-off sequences in order to continuously provide regions of the filter for the water to come through unimpeded by blowing pressurized air.

In an alternate form of the present disclosure (see FIG. 13, as opposed to that which is portrayed in FIG. 12), there is not a liquid exit passageway (158) running through each rim (163) through which liquid sewage is dispelled (157). Rather, there is a channel (162) for sewage to flow through the rim (163) from one section to another and then out the bottom.

### LIST OF PARTS NUMBERS

In connection with the figures, the following list of the names of the parts of the present disclosure are noted:

| Numbers | Parts, Etc. |
|---|---|
| 40 | sewage; |
| 41 | inline polymer mixer; |
| 42 | inline mixing and flocculating unit; |
| 43 | chemical pH adjustment; |
| 44 | sand bed; |
| 45 | sludge retrieval; |
| 46 | sludge; |
| 48 | channels; |
| 49 | sand bed enclosures; |
| 50 | non-porous layer; |
| 51 | dividing wall; |
| 52 | support upon which dividing wall is positioned; |
| 53 | porous layer positioned directly above non-porous layer (50); |
| 54 | projection of porous layer (54); |
| 55 | non-porous pipe; |
| 56 | hole in non-porous pipe (56); |
| 57 | layer of sand underlaying sand-cell media section; |
| 58 | single sand-cell; |
| 59 | channel running through interior of single sand-cell; |
| 60 | point of intersection of 4 individual sand-cells; |
| 61 | layer of sand overlaying sand-cell media section; |
| 62 | channel into which sludge is poured |
| 63 | loader or other loading equipment; |
| 64 | wheel of loader or other loading equipment; |
| 65 | sand-cell media section; |
| 80 | mixer-flocculator unit; |
| 81 | input conduit (influent end of mixer); |
| 82 | flanges; |
| 82a | flange; |
| 83 | mixing zone 1; |
| 84 | polymer or flocculant injection lines; |
| 85 | manifold; |
| 86 | quick connect; |
| 87 | adjustable baffleplate placed at an angle; |
| 87a | pivot attachment; |
| 88 | electrical unit; |
| 88a | threadedly adjustable rod; |
| 89 | mixing zone 2; |
| 90 | fixed, vertical baffle; |
| 91 | drainage plug; |
| 92 | fixed, horizontal baffles; |
| 93 | mixing zone 3; |
| 94 | walls; |
| 95 | flush plug; |
| 96 | fixed, vertical baffle; |
| 97 | mixing zone 5; |
| 98 | recirculation baffles; |
| 99 | mixing zone 4; |
| 100 | output conduit; |
| 101 | mixer-flocculating system; |
| 102 | liquid in; |
| 103 | elbows; |
| 104 | vertical inlet pipe segment; |
| 105 | downflow segment; |
| 106 | bottomflow segment; |
| 107 | upflow segment; |
| 108 | vertical exit pipe segment; |
| 109 | liquid out; |
| 110 | transportable dewatering trailer; |
| 111 | recycle segment; |
| 112 | barrel; |
| 113 | dip tube; |
| 114 | motor; |
| 115 | control valve; |
| 125 | sludge retriever; |
| 126 | shaft; |
| 127 | multiple 3 inch tines/teeth; |
| 128 | rotaty; |
| 129 | lower pivoted arm attaching sludge retriever to |
| | front-end loader; |
| 130 | upper pivoted arm attaching sludge retriever to |
| | front-end loader; |
| 131 | ball pivot; |
| 132 | arm; |
| 133 | two cubic yard bucket/hopper; |
| 134 | dried sludge; |
| 135 | rotary drum; |
| 136 | air flow grill or filter; |
| 137 | lower side; |
| 138 | front end; |
| 139 | arm; |
| 140 | vertical slot; |
| 141 | short horizantal slots; |
| 150 | screen filter; |
| 151 | rib; |
| 152 | high pressure air jet; |
| 153 | wall; |
| 154 | circular air chamber; |
| 155 | manifold; |
| 156 | pressurized air in; |
| 157 | liquid sewage out; |
| 158 | liquid exit ring; |
| 159 | rim ring; |
| 160 | passageway for sewage; |
| 161 | bolt; |
| 162 | channel for sewage; |
| 163 | rim; |
| 164 | inline pneumatic dewatering tube; |
| 165 | polymer mixing-feeding system; |
| 166 | tube; |
| 167 | inner chamber; |
| 168 | vessel; |
| 169 | retention chamber; |
| 170 | exit tube; |
| 171 | access plate; |
| 172 | tube; |
| 173 | water-polymer mixing unit; |
| 174 | cheek valve; |
| 175 | hollow shaft; |
| 176 | aspirator; |
| 177 | motor; |
| 178 | seal; |
| 179 | check valve; |
| 180 | ball valve; |
| 181 | flow indicator; |
| 182 | filming process; and |
| 183 | tube. |

In connection with the figures, the following list of the names of the parts of a prior art invention [U.S. Pat. No. 5,248,416 (Howard)] are noted:

| | |
|---|---|
| 212 | Upper right hand conduit/system input; |
| 214 | multiple polymer ejectors; |
| 217 | conduit; |
| 220 | moveable flutter or ledge; |
| 222 | conduit; |
| 222a | conduit; |
| 224 | conduit; |
| 226 | output conduit/system output; |
| 229 | recirculating conduit; |
| 229a | pivotal flaps on recirculating conduit; and |
| 230 | support bracing. |

With reference to the embodiment shown in FIG. 5A, an alternate embodiment of the sewage dewatering processes and equipment apparatuses is shown with alterations made on the interior and exterior of the apparatuses. In various embodiments, the alterations in the mixing-flocculating unit of FIG. 5A may improve mixing of the activated or non-activated polymer, coagulant, and/or any other liquid or gas form into the apparatus flow stream and/or any other liquidized material entering into the apparatus. In various embodiments, the improvements help to create a more thorough mixing of the applied compound into the flow or recirculating stream going through the apparatus. Exemplary embodiments of the sewage dewatering equipment apparatus and processes may use or be made from materials that can withstand the psi interior loading of the flow pressure rating passing through the apparatus size, which in some embodiments can be from ½ inch to 48 inches in circumference. Various embodiments may be adjusted based on the volume load and viscosity of loaded material. Exemplary materials include steel, PVC, aluminum, composite materials, vinyl, or combinations thereof. In some embodiments, preferable materials include stainless steel.

Referring to FIG. 5A, in various embodiments, there may be a plurality of openings 384, such as from about 2 to about 8 (e.g., in some embodiment preferably 4) openings, with a quick disconnect and with fixed nipples and hoses arranged circumferentially around inlet end 354, which is the interface where flanges 382 of conduit pipe 381 and downflow segment are coupled, of the apparatus.

In some embodiments, an additional spool apparatus 350 having lengths that range between 4″ to 12″, (e.g., 1 independent inlet being preferably 6″ in length), circumference of ½ inch to 48 inches, may be attached to the mixing-flocculating unit of FIG. 5A for sewage dewatering equipment apparatus and processes. In one embodiment, an additional spool apparatus 350 may include from 1 to 6 spool apparatuses 350. Some embodiments may include from about 2 to about 6 inlet spool apparatuses 350 attaching to inlet end 354 of the improved sewage dewatering process and equipment apparatus, for example, via bolts or proper connections with gaskets or other sealing agents, as would be recognized by an ordinary skilled artisan with the benefit of this disclosure. In some embodiments, spool apparatus 350 may tangential openings 352 in fluid communication with quick-connect couplers and hosing allowing for the introduction of additional gas, liquid, or combination of materials into the flow stream of a primary apparatus by liquid or gas injection manifold 302 and liquid or gas injection line 303. In one embodiment, spool apparatus 350 may comprise between about 2 to about 6 tangential openings 352. In another embodiment, spool apparatus 350 may comprise 4 tangential openings 352.

In various embodiments, the apparatuses and/or processes may be improved through introduction of the activated polymer, non-activated polymer, coagulant, and/or any liquidized material or gaseous material entering into the flow stream (via liquid or gas injection manifold 302 and liquid or gas injection line 303) to be thoroughly mixed by restricting the flow by strategically arranged fixed baffles discussed further herein. In various embodiments, the baffles may leave a decrease pressure of the flow behind it creating turbulent vortex, hydraulic increase throughput, and recirculation inside the apparatus. Moreover, in various embodiments, the baffles may be fixedly mounted horizontally and positioned with the mixing-flocculating unit of FIG. 5A from between ⅛ to ⅔ of the distance spanning from the inside entrance of conduit 381 to the outlet apparatus pipe 300. The fixed baffles function to veer the mixing flow materials in certain directions at key locations as discussed further herein.

Referring to FIG. 5A, fixed items 88a and 87a of the mixing-flocculating unit of FIG. 5, are modified to a fixed baffle 387 located on the vertical inlet side before or upstream of top horizontal transfer line or recirculating pipe 305. In various embodiments, fixed baffle 387 is positioned on the inlet side of the mixing-flocculating unit of FIG. 5A before or upstream of the top horizontal line or recirculating (recycling) pipe 305 and may help to create a first turbulent vortex and may again be utilized when the flow is recycled through the medial plane, producing turbulent vortex. In various embodiments, areas of higher influent pressure may hit stationary baffle 387 leaving a decrease pressure behind the increased hydraulic throughput causing a better backpressure mix and producing a partial backflip or rolling action of the sludge or solution without restricting the flow of the polymerized or solution treated sludge in zone 1. To accelerate the growth of the floc and the separation of the solids from the liquid, a baffle 390 further restricts the flow through the apparatus and thereby accelerates sludge flow past the top horizontal line 305 through zone 2 (reference number 396), which continues to mix/blend the sludge while passing over the strategically placed baffles 392 throughout the apparatus bottom section 394. Bottom section 394 with baffles 392 and ports 391, 395 are configured in a substantially similar manner to the mixing-flocculating unit of FIG. 5 as previously described. Similarly, top horizontal line or recirculating pipe 305 with baffles 398 are configured in a substantially similar manner to the mixing-flocculating unit of FIG. 5 as previously described.

As also shown in FIG. 5A, baffle 390′ is located in zone 5 (reference number 388) on the discharge side of the mixing-flocculating unit along vertical outlet pipe 397. Baffle 390 functions to reduce the rapid flow of sludge caused by inlet baffle 387 in zone 1 and to create a venturi environment causing pressure drop, thereby creating recirculation of the flocced sludge or materials through top horizontal line 305 of the apparatus zone 4 (reference number 399) and extending into the incoming sludge flow in zone 2 (reference number 396). The recirculated flow may carry unused particles or charge sites either positive or negative of the polymer, coagulant or agent causing a reduction of new coagulant or other supplied material needed to properly floc or treated incoming materials or sludge flow. The improved delivery of the prepared solution injected into the flowing stream according to various embodiments may allow for enhanced mixture or floc formation, any sludge, combined compounds, organic or non-organic, gases, water solution or animal waste is thoroughly mixed and recirculated in the improved sewage dewatering processes and equipment apparatuses for the separation of the liquid from solids delivered to a quick dry filter beds, sand beds, lagoons, catch basin, lake, holding tank, filter, micro filters, porous surface, seepage sludge bags or any mechanical dewatering device.

As also shown in FIG. 5A, cleanout ports 391, 395 are located on the outer side of bottom horizontal portion or apparatus line 394 of the apparatus shown in FIG. 5A. An opening port 356 is located on the inlet vertical side opposite of the mixing zone 1 and 2 (reference numbers 383, 396) is designed to accept a pressure gauge 304 to monitor the apparatus's internal pressure (e.g., psi). In various embodiments, opening port 356 may also be designed to accept a flow monitoring device, viscosity measuring device, a port signal control to measure sludge flow through the apparatus, or any combination thereof. In some embodiments, any of the three aforementioned ports may be designed to receive a pH adjustment solution to alter a condition the sludge characteristics, for example to lower or raise pH of the flow based on the injected material. In various embodiments, all ports may be used to receive a second chemical or dual polymer process or to inject water to thin down the sludge concentration, to drain or force liquid into the apparatus from one port and drain from the other port or drain from both ports, to receive other products such as water, chemicals, or any combination thereof as a side stream flow to remove a portion of the prepared mix for other uses or apparatuses.

Furthermore, it will be recognized by a person of ordinary skill that the apparatuses, systems, and methods disclosed herein may be used and adapted to a wide variety of uses or industries. For example, the apparatuses and methods disclosed herein may be used in industry to mix various chemicals or liquefied gases.

Exemplary industries include the biosolids industry, water plant residuals, lagoons, agriculture (e.g., concentrated animal feeding operation (CAFO) operations (e.g., for both solids and liquids)), T-Water industry, the coal industry, the paper industry, storm water surge management systems, and the oil and gas industry (e.g., fracking).

For example, the systems, apparatuses and methods may be adapted by using materials that would not be corroded by such chemicals or liquefied gases based on the industrial application. Exemplary chemicals or categories of chemicals include buffer solutions, citric acid, muriatic acid, potassium hydroxide, sodium hydroxide, sodium hypochlorite, sodium sulfite, sulfuric acid, aluminum chloride, aluminum chlorohydrate, aluminum sulfate, calcium chloride, ferric chloride, ferrous chloride, sodium aluminate, various polymers (e.g., cationic polymers and/or anionic polymers), metal precipitants, sludge conditioners, or combinations thereof.

While this disclosure has been described as having exemplary designs, the present disclosure can be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains and which fall within the limits of the appended claims.

### NUMERAL IDENTIFICATION FOR FIG. 5A

300. Apparatus pipe (out)
302. Liquid or gas injection with manifold
303. Liquid or gas injection line into manifold
304. Pressure gage or monitoring apparatus
305. Top horizontal recirculating pipe
350. Spool apparatus
352. Tangential openings
354. Inlet end
356. Opening port
381. Conduit pipe (in)
382. Flanges
383. Mixing zone 1
384. Polymer flocculants or chemical injection lines
385. Manifold
386. Quick connect
387. Fixed Baffle
388. Mixing zone 5
389. Vertical inlet Pipe
390. Baffle
390′. Baffle
391. Opening for Cleanout, Instrumentation gauge, Injection of liquid or gas and side
stream outlet
392. Baffle
393. Mixing zone 3
394. Bottom of horizontal apparatus line
395. Discharge ports, injection port or side stream outlet
396. Mixing zone 2
397. Vertical outlet pipe
398. Recirculation baffles
399. Mixing zone 4

What is claimed is:

1. A mixing-flocculating unit comprising:
an inlet section;
an outlet section fluidly connected to the inlet section; and
a bottom section and a recycling section fluidly coupled to the inlet and outlet sections;
the inlet section includes a first baffle positioned upstream of the recycling section;
the inlet section further includes a second baffle, the outlet section includes a baffle, the recycling section includes a plurality of baffles, and the bottom section includes a plurality of baffles.

2. The mixing-flocculating unit of claim 1, wherein the first baffle is non-flexible and fixed to the inlet section increases the velocity of liquid flow through the inlet section.

3. The mixing-flocculating unit of claim 2, wherein the first baffle restricts a liquid flow through the inlet section by between 50% and 80%.

4. The mixing-flocculating unit of claim 3, wherein the first baffle of the inlet section restricts a liquid flow through the inlet section by about 50%.

5. The mixing-flocculating unit of claim 1, wherein the baffles for the inlet section, the outlet section, the recycling section, and the bottom section are non-flexible and fixed.

6. The mixing-flocculating unit of claim 1, wherein the recycling section has a diameter that is smaller than diameters of the inlet section, the outlet section, and the bottom section such that a venturi effect is created to draw liquid flow into the recycling section.

7. A mixing-flocculating unit comprising:
an inlet section;
an outlet section fluidly connected to the inlet section;
a bottom section and a recycling section fluidly coupled to the inlet and outlet sections, the recycling section having a diameter smaller than diameters of the inlet section, the outlet section, and the bottom section; and
a first baffle positioned in the inlet section upstream of the recycling section, the first baffle is non-flexible and fixed to the inlet section increases the velocity of liquid flow through the inlet section;
wherein the inlet section includes a second baffle, the outlet section includes a baffle, the recycling section includes a plurality of baffles, and the bottom section includes a plurality of baffles.

8. The mixing-flocculating unit of claim 7, wherein the first baffle of the inlet section is configured to increase liquid flow velocity.

9. The mixing-flocculating unit of claim 8, wherein the baffle of the outlet section is configured to reduce liquid flow velocity.

10. The mixing-flocculating unit of claim 9, wherein the plurality of baffles for the bottom section are arranged in a serpentine pattern such that liquid flow velocity is reduced.

11. The mixing-flocculating unit of claim 7, wherein the smaller diameter of the recycling portion creates a venturi effect to draw liquid flow from the outlet section into the recycling section.

12. A mixing-flocculating unit comprising:
an inlet section coupled to a spool apparatus, the spool apparatus configured to provide for injection of gas, liquid, or combination of materials into liquid flow entering the inlet section;
an outlet section fluidly connected to the inlet section;
a bottom section and a recycling section fluidly coupled to the inlet and outlet sections, the recycling section having a diameter smaller than diameters of the inlet section, the outlet section, and the bottom section; and
a first baffle positioned in the inlet section upstream of the recycling section;
wherein the inlet section includes a second baffle, the outlet section includes a baffle, the recycling section includes a plurality of baffles, and the bottom section includes a plurality of baffles.

13. The mixing-flocculating unit of claim 12, wherein the spool includes a plurality of tangential openings in fluid communication with a liquid gas injection line such that gas can be injected into liquid flow when entering the inlet section.

14. The mixing-flocculating unit of claim 12, wherein the smaller diameter of the recycling portion creates a venturi effect to draw liquid flow from the outlet section into the recycling section.

15. The mixing-flocculating unit of claim 12, wherein the first baffle and the second baffle of the inlet section are configured to increase liquid flow velocity.

16. The mixing-flocculating unit of claim 15, wherein the baffle of the outlet section is configured to reduce liquid flow velocity.

17. The mixing-flocculating unit of claim 16, wherein the plurality of baffles for the bottom section are arranged in a serpentine pattern such that liquid flow velocity is reduced.

18. The mixing-flocculating unit of claim 12, wherein the first baffle is non-flexible and fixed to the inlet section increases the velocity of liquid flow through the inlet section.

19. The mixing-flocculating unit of claim 18, wherein the first baffle restricts a liquid flow through the inlet section by between 50% and 80%.

20. The mixing-flocculating unit of claim 19, wherein the first baffle of the inlet section restricts a liquid flow through the inlet section by about 50%.
